(19) United States
(12) Patent Application Publication
(10) Pub. No.: US 2025/0078297 A1
(43) Pub. Date: Mar. 6, 2025

(54) SYSTEM AND METHOD FOR 3D PROFILE MEASUREMENTS USING COLOR FRINGE PROJECTION TECHNIQUES

(71) Applicant: National Sun Yat-sen University, Kaohsiung City (TW)

(72) Inventors: Wei-hung SU, Kaohsiung City (TW); Pei-chi LI, Kaohsiung City (TW)

(21) Appl. No.: 18/826,321

(22) Filed: Sep. 6, 2024

(30) Foreign Application Priority Data
Sep. 6, 2023 (TW) 112133945

(51) Int. Cl. G06T 7/521; G01B 11/25; G06T 7/90

(52) U.S. Cl. CPC G06T 7/521; G01B 11/254; G06T 7/90; G06T 2207/10024

(57) ABSTRACT

A system and a method for 3D profile measurements using color fringe projection techniques are provided. The system comprises a color fringe pattern, a digital projector, a color photosensitive coupling device, and a processor. When the digital projector projects the color fringe pattern onto an object to generate color projected fringes, the absolute phase of the object can be calculated by using the horizontal displacement of the color projected fringes, thereby improving the measurement accuracy.

### CROSS REFERENCE TO RELATED APPLICATIONS

This application claims priority to Taiwan Application Serial Number 112133945, filed on Sep. 6, 2023, which is incorporated herein by reference.

### FIELD OF THE INVENTION

Present disclosure relates to a system and a method for 3D profile measurements, and more particularly to a system and a method for 3D profile measurements using color fringe projection techniques.

### BACKGROUND OF THE INVENTION

Among the conventional technologies, the shape measurement technology of dynamic objects is mostly based on light projection or stripe projection technology on the structure, combined with single-shot techniques. The main measurement principle is to project a chordal pattern onto a dynamic object, and the fringe distribution on the surface of the object is recorded by a camera (CCD) from another perspective. The fringe distribution captured by the camera will be distorted along with the outline of the object, so the phase distortion degree of the fringes is related to the depth change of the object, which is called the phase-to-depth relation, finding the relationship can further obtain the three-dimensional coordinates of the surface of the dynamic object. Furthermore, the fringe order of the object with deep faults on its surface cannot be identified purely from the image, so a fringe encoding method was developed to identify the fringe order, thereby achieving the purpose of phase unwrapping.

With the detection needs in various special environments, the optical architectures (or vehicles) and signal processing technologies are also diverse. Generally, for shape measurements of static objects that require high precision, phase-shifting technique is often used to extract the fringe phase. Because it requires more than three projections and the same number of image captures, it is a multiple-shot technique, so it is suitable for static objects. Repeated measurements can also help improve accuracy. However, fringe projection using phase-shifting technique is often only suitable for measuring static objects.

On the other hand, for situations where dynamic objects need to be measured in real time, the Fourier transform method is often used instead of the phase-shifting technique. Because the Fourier transform method only needs to capture a fringe projection image (which belongs to the one-shot technology), it can complete the fringe phase extraction for dynamic objects. However, the information in a single image is easily interfered by the external environment and misled. For example, the shadow area is mistakenly recognized as a dark pattern or area with a large period, which is easily affected by noise and misjudges the Z-axis position of its grayscale extreme value. Compared to phase-shifting technique, the Fourier transform methods extract less accurate phase values.

As a result, it is necessary to provide a system and a method for 3D profile measurements using color fringe projection techniques to solve the problems existing in the conventional technologies, as described above.

### SUMMARY OF THE INVENTION

An object of present disclosure is to provide a system and a method for 3D profile measurements using color fringe projection techniques. When the object is projected with a color fringe pattern, the distortion of the color fringe projected on the object can be used to restore the three-dimensional profile. Only one pattern projection is required for the profile measurement. Consequently, it is available in applications of dynamic objects. Phase of the projected fringes is extracted by the phase-shifting technique. Hence its systematic accuracy is the same as those evaluated by typical three-step phase-shifting techniques, and better than those evaluated by the Fourier transform method.

To achieve the above object, the present disclosure provides a system for 3D profile measurements using color fringe projection techniques, which comprises a color fringe pattern, a digital projector, a color photosensitive coupling device, and a processor. The color fringe pattern comprises a red sinusoidal pattern, a green sinusoidal pattern, and a blue sinusoidal pattern, wherein each sinusoidal pattern differs from the other two sinusoidal patterns with a phase-shifted value of 2π/3. The digital projector is disposed before a projection plane, wherein the color fringe pattern is disposed on the projection plane, the digital projector is configured to project the color fringe pattern on an object and colorful fringes are projected on a surface of the object. Specifically, the digital projector projects the color fringe pattern located on the xₚ-yₚ plane onto the inspected object posited in (x, y, z) coordinate.

The color photosensitive coupling device is disposed on an imaging plane, wherein the imaging plane and the projection plane are located in different planes, and the color photosensitive coupling device is configured to capture the colorful fringes to obtain a color fringed image. Specifically, the colorful fringes projected on the object are then recorded by the color photosensitive coupling device from another view angle located on the x_{d}-y_{d} plane.

The processor is coupled outside the color photosensitive coupling device and is configured to: analyze the color fringed image to obtain a first grayscale image, a second grayscale image, and a third grayscale image, wherein the first grayscale image is derived from a red channel, the second grayscale image is derived from a green channel, and the third grayscale image is derived from the blue channel; perform phase acquisition on the first grayscale image, the second grayscale image, and the third grayscale image to obtain a wrapped phase map of the colorful fringes located on the surface of the object; perform phase unwrapping of the wrapped phase map to obtain an absolute phase corresponding to the object; and calculate a depth from any point on the surface of the object to a reference plane based on the absolute phase, such as using the phase-to-depth relation (derived from the database module), to obtain a three-dimensional shape of the object.

In one embodiment of present disclosure, the system comprises a database module coupled the processor, and the database module is configured to establish the relevant information between the depth of the z-axis and the absolute phase of the object.

To achieve the above object, the present disclosure provides a method for 3D profile measurements using color fringe projection techniques, which comprises a superposition step, superimposing a red sinusoidal pattern, a green sinusoidal pattern, and a blue sinusoidal pattern by a processor to form a color fringe pattern, wherein each sinusoidal pattern differs from the other two sinusoidal patterns with a phase-shifted value, specifically, each sinusoidal pattern differs from the other two sinusoidal patterns with a phase-shifted value of 2π/3; a projection step, using a digital projector to project the color fringe pattern onto an object, and colorful fringes are projected on a surface of the object; a capture step, using a color photosensitive coupling device to capture the colorful fringes to obtain a color fringed image; an image processing step, using the processor to analyze the color fringed image to obtain a first grayscale image, a second grayscale image, and a third grayscale image, wherein the first grayscale image is derived from a red channel, the second grayscale image is derived from a green channel, and the third grayscale image is derived from the blue channel; a phase shift step, performing phase acquisition on the first grayscale image, the second grayscale image, and the third grayscale image by the processor to obtain a wrapped phase map of the colorful fringes located on the surface of the object; a phase unwrapping step, performing phase unwrapping of the wrapped phase map by the processor to obtain an absolute phase corresponding to the object; and a calculation step, calculating a depth from any point on the surface of the object to a reference plane based on the absolute phase, such as using the phase-to-depth relation (derived from the database module), to obtain a three-dimensional shape of the object.

In one embodiment of present disclosure, in the superposition step, the red sinusoidal pattern comprises a phase-shifted value of 0, the green sinusoidal pattern comprises a phase-shifted value of 2π/3, and the blue sinusoidal pattern comprises a phase-shifted value of 4π/3.

In one embodiment of present disclosure, in the image processing step, an equation for the phase and light intensity of the first grayscale image, the second grayscale image and the third grayscale image is:

$${I}_{d}^{( k )} ( {x}_{d} , {y}_{d} ) = {A}_{d} ( {x}_{d} , {y}_{d} ) + {B}_{d} ( {x}_{d} , {y}_{d} ) cos ( {φ}_{d} ( {x}_{d} , {y}_{d} ) - 2 π ( k - 1 ) / 3 ) ;$$

wherein x_{d} and y_{d} represent an imaging plane of the color fringed image; I_{d}^{(k)}(x_{d}, y_{d}) represents the light intensity of the grayscale image, k=1 represents the first grayscale image, k=2 represents the second grayscale image, k=3 represents the third grayscale image; A_{d} is DC term of the grayscale images, B_{d} is amplitude of the grayscale images; φ_{d} is a phase of the fringes of the first grayscale image, the second grayscale image and the third grayscale image.

In one embodiment of present disclosure, in the phase shift step, an equation for the phases of fringes of the colorful fringes is:

$${φ}_{w} ( {x}_{d} , {y}_{d} ) = {tan}^{- 1} [ \frac{{\sum }_{k = 1}^{3} {I}_{d}^{( k )} ( {x}_{d} , {y}_{d} ) sin [ 2 ( k - 1 ) π / 3 ]}{{\sum }_{k = 1}^{3} {I}_{d}^{( k )} ( {x}_{d} , {y}_{d} ) cos [ 2 ( k - 1 ) π / 3 ]} ] ;$$

wherein x_{d} and y_{d} represent an imaging plane of the color fringed image; φ_{w}(x_{d}, y_{d}) represents the phase of the colorful fringes limited to between π and −π; k=1 represents the first grayscale image, k=2 represents the second grayscale image, k=3 represents the third grayscale image.

In one embodiment of present disclosure, in the calculation step, the processor calculates the phase difference between the surface of the object and the reference plane based on the absolute phase, an equation for the depth and the phase difference is:

$$\vec{MN} = {d}_{0} \frac{{φ}_{N} - {φ}_{Q}}{2 π} cos {θ}_{0} ;$$

wherein a projection beam L passes through the reference plane M and intersects on the surface N of the object; the intersection point with the reference plane M after reflection is Q; the distance between light and dark fringes projected onto the reference plane is d₀; the phase of N is φ_{N}; the phase of Q is φ_{Q}; an angle between a normal line of the projection beam L and the reference plane is θ₀.

It should be noted that whether it is the digital projector or the color photosensitive coupling device, the images projected or captured have color aberration problems, especially the crosstalk between the channels of the color photosensitive coupling device. Specifically, the crosstalk between each channel will produce additional interference, such as the projection of a pure red pattern, but it will appear in the image captured by the green channel and the blue channel at the same time, resulting in a non-negligible deviation in the extracted phase. Moreover, the color of the object will also affect the phase accuracy. For example, a pure red object will make the image captured by the green channel and the blue channel darker, and the gray scale value of its fringe will be smaller. In order to solve the chromatic aberration and crosstalk, the following first correction tool was designed. Furthermore, whether it is the digital projector or the color photosensitive coupling device, the lenses used often do not have effects of telecentric imaging formation, so that d₀ and θ₀ are non-constant values and change with position, so further correction is required.

In one embodiment of present disclosure, after the calculation step, the method further comprises a parameter correction step, the parameter correction step comprises a first projection sub-step, a first image capture sub-step, a first processing sub-step, and a first calculation sub-step. In the first projection sub-step, the digital projector is used to project the color fringe pattern onto a first correction tool, and a first projection fringe is formed on a surface of the first correction tool. The first correction tool is a planar object, the color and reflectivity of the surface of the planar object are close to or equal to the surface of the object. If the colors of the images captured by the planar object and the object are different, the phase extracted by the first correction tool and the phase extracted from the object have a non-negligible deviation. In the first image capture sub-step, an operator moves the first correction tool to z-axis positions along a z-axis and uses the color photosensitive coupling device to capture images of the first projection fringe to obtain a plurality of first color fringed images corresponding to the z-axis positions. In the first processing sub-step, the processor is uses to process the first color fringed images to obtain a plurality of first absolute phases corresponding to the first correction tool located at the z-axis positions. In the first calculation sub-step, the processor uses the least squares method to perform calculations to obtain a depth parameter in an equation between the first absolute phases and the z-axis, wherein the equation is:

$$z = {\sum }_{n = 0}^{N} {C}_{n} {φ}_{d}^{n} ;$$

wherein a depth of the z-axis is z; a number of z-axis positions is N; the depth parameter is Cₙ; the first absolute phases is φ_{d}.

In one embodiment of present disclosure, the parameter correction step further comprises a second image capture sub-step, a second processing sub-step, and a second calculation sub-step. In the second image capture sub-step, the operator moves a second correction tool to z-axis positions along a z-axis, wherein the second correction tool is a planar object, and the surface of the planar object is painted with chordal stripes. These chordal stripes are arranged at an angle of 45 degrees to the horizontal direction, and the period T is a known fixed value. The color of the chordal stripes does not need to be limited (at least it is not a gradient between white and black), as long as the color photosensitive coupling device can capture a fringe image in any channel. The operator further uses the color photosensitive coupling device to capture images of a color oblique picture 105 (chordal stripes arranged at an angle of 45 degrees) of the second correction tool to obtain a plurality of second color fringed images corresponding to the z-axis positions. In the second processing sub-step, a fringe image of at least one channel is captured, and the fringe in the fringe image is chordal (even with crosstalk), the processor uses a one-dimensional Fourier transform method to perform phase extraction of the second color fringed images in the horizontal direction (x-axis) and the vertical direction (y-axis) to obtain a plurality of second absolute phases (φₓ and φ_{y}) corresponding to the z-axis positions of the second correction tool. Since the periods of these chordal stripes are known, the x-axis position and y-axis position can be calculated from the absolute phases (φₓ and φ_{y}), and the equations are: φₓ=2πx/Tₓ; φ_{y}=2πy/T_{y}; Tₓ=T_{y}=T cos(π/4). In the second calculation sub-step, the processor calculates x-axis positions and y-axis positions corresponding to the z-axis positions based on the second absolute phases, and uses the least squares method to perform calculations to obtain horizontal parameters of an equation comprising the z-axis positions and the x-axis positions and vertical parameters of an equation comprising the z-axis positions and the Y-axis positions, wherein the equations are:

$$x = {a}_{1} z + {a}_{0} ;$$

$$y = {b}_{1} z + {b}_{0} ;$$

wherein a horizontal length of the x-axis is x; a vertical length of the y-axis is y; a depth of the Z axis is z; the horizontal parameters are a₁ and a₀; the vertical parameters are b₁ and b₀.

In one embodiment of present disclosure, the first correction tool and the second correction tool are flat objects, and the depth of the plane objects is less than one tenth of a sampling point distance of the color photosensitive coupling device.

As described above, the present disclosure can accurately identify the phase by phase shift, and then use the phase to restore the three-dimensional shape. When the object is projected with a color fringe pattern, the distortion of the color fringe projected on the object can be used to restore the three-dimensional profile. Only one pattern projection is required for the profile measurement. Consequently, it is available in applications of dynamic objects. Phase of the projected fringes is extracted by the phase-shifting technique. Hence its systematic accuracy is the same as those evaluated by typical three-step phase-shifting techniques, and better than those evaluated by the Fourier transform method. Furthermore, the present disclosure only uses the color photosensitive coupling device to capture a color fringed image by facing the object to obtain the phase distribution information of the object, and then restore the three-dimensional shape. It can significantly reduce the measurement time required in research and improve work efficiency. The present disclosure only needs to take a momentary photo of a dynamic object, Phase shift technology and phase unwrapping technique are used to obtain continuous phase distribution and restore the three-dimensional shape of the object, which is beneficial to the measurement of dynamic objects.

### DESCRIPTION OF THE DRAWINGS

FIG. 1 is a schematic diagram of a system for 3D profile measurements using color fringe projection techniques according to the present disclosure.

FIG. 2 is a schematic diagram of a color photosensitive coupling device, a processor, and a database module of the system for 3D profile measurements using color fringe projection techniques according to the present disclosure.

FIG. 3A is a schematic diagram of a color fringe pattern of the system for 3D profile measurements using color fringe projection techniques according to the present disclosure.

FIG. 3B is a schematic diagram of a red sinusoidal pattern of the system for 3D profile measurements using color fringe projection techniques according to the present disclosure.

FIG. 3C is a schematic diagram of a green sinusoidal pattern of the system for 3D profile measurements using color fringe projection techniques according to the present disclosure.

FIG. 3D is a schematic diagram of a blue sinusoidal pattern of the system for 3D profile measurements using color fringe projection techniques according to the present disclosure.

FIG. 4 is a flow chart of a method for 3D profile measurements using color fringe projection techniques according to the present disclosure.

FIG. 5 is a flow chart of a parameter correction step of the method for 3D profile measurements using color fringe projection techniques according to the present disclosure.

FIG. 6 is another flow chart of a parameter correction step of the method for 3D profile measurements using color fringe projection techniques according to the present disclosure.

FIG. 7 is a schematic diagram of the depth and phase difference between an object and a reference plane in a calculation step of the method for 3D profile measurements using color fringe projection techniques according to the present disclosure.

FIG. 8 is a schematic diagram of component settings in the parameter correction step of the method for 3D profile measurements using color fringe projection techniques according to the present disclosure.

FIG. 9 is another schematic diagram of component settings in the parameter correction step of the method for 3D profile measurements using color fringe projection techniques according to the present disclosure.

### DETAILED DESCRIPTION OF THE PREFERRED EMBODIMENTS

The structure and the technical means adopted by present disclosure to achieve the above and other objects can be best understood by referring to the following detailed description of the preferred embodiments and the accompanying drawings. Furthermore, directional terms described by present disclosure, such as upper, lower, front, back, left, right, inner, outer, side, longitudinal/vertical, transverse/horizontal, etc., are only directions by referring to the accompanying drawings, and thus the used directional terms are used to describe and understand present disclosure, but present disclosure is not limited thereto.

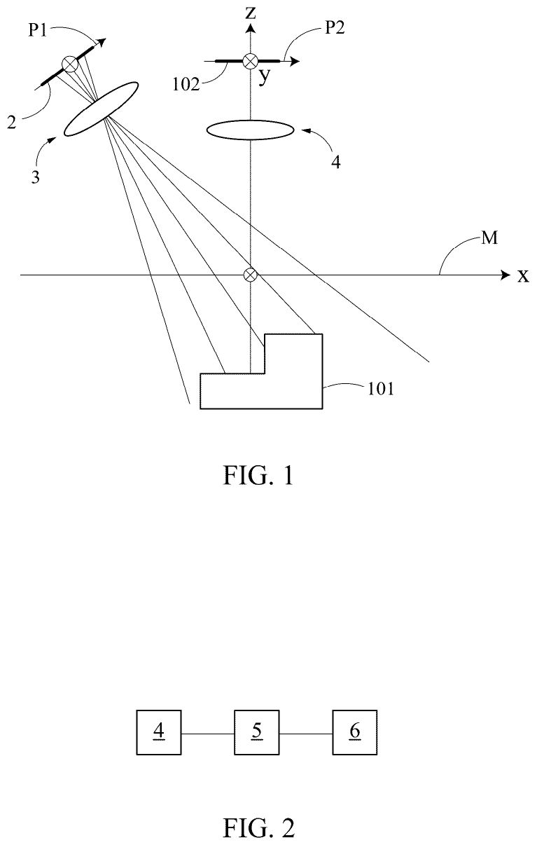

Please refer to FIG. 1 and FIG. 2, a system for 3D profile measurements using color fringe projection techniques according to a preferred embodiment of present disclosure is illustrated. As shown, the system comprises a color fringe pattern 2, a digital projector 3, a color photosensitive coupling device 4, a processor 5, and a database module 6. The detailed structure of each component, assembly relationships, and principles of operation in present disclosure will be described in detail hereinafter.

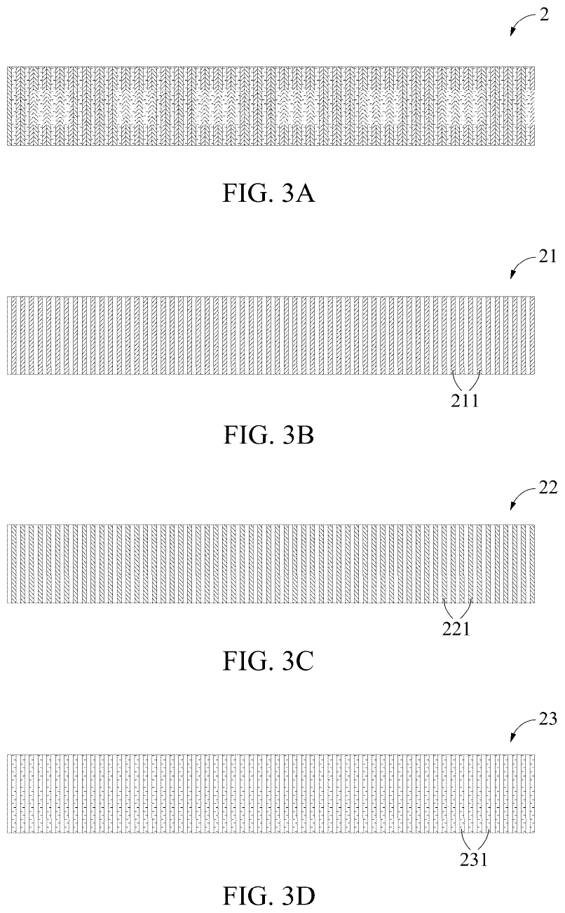

Please refer to FIG. 3A to FIG. 3D, the color fringe pattern 2, such as an RGB fringe pattern, comprises a red sinusoidal pattern 21, a green sinusoidal pattern 22, and a blue sinusoidal pattern 23, wherein the red sinusoidal pattern 21, the green sinusoidal pattern 22, and the blue sinusoidal pattern 23 are superimposed and have different phases. Specifically, the red sinusoidal pattern 21 has a plurality of red stripes 211, the green sinusoidal pattern 22 has a plurality of green stripes 221, and the blue sinusoidal pattern 23 has a plurality of blue stripes 231.

Please refer to FIG. 1 and FIG. 2, the digital projector 3 is disposed before a projection plane P1, the color fringe pattern 2 is disposed on the projection plane P1, and the digital projector 3 is configured to project the color fringe pattern 2 on an object 101, so that colorful fringes are projected on a surface of the object 101.

Please refer to FIG. 1 and FIG. 2, the color photosensitive coupling device 4, such as a color camera, is disposed on an imaging plane P2, wherein the imaging plane P2 and the projection plane P1 are located in different planes, and the color photosensitive coupling device 4 is configured to capture the colorful fringes to obtain a color fringed image 102.

Please refer to FIG. 1 and FIG. 2, the processor 5 is coupled the color photosensitive coupling device 4. The processor 5 is configured to analyze the color fringed image 102 to obtain a first grayscale image, a second grayscale image, and a third grayscale image, wherein the first grayscale image is derived from a red channel, the second grayscale image is derived from a green channel, and the third grayscale image is derived from the blue channel.

Please refer to FIG. 1 and FIG. 2, the processor 5 performs phase acquisition on the first grayscale image, the second grayscale image, and the third grayscale image to obtain a wrapped phase map of the colorful fringes located on the surface of the object 101 and performs phase unwrapping of the wrapped phase map to obtain an absolute phase corresponding to the object 101. In other words, phase unwrapping technique is used to obtain a continuous phase distribution. Finally, the processor 5 is used to calculate a depth from any point on the surface of the object 101 to a reference plane M based on the absolute phase to obtain a three-dimensional shape of the object 101.

Please refer to FIG. 1 and FIG. 2, the database module 6 is coupled the processor 5, and the database module 6 is configured to establish the relevant information between the depth of the z-axis and the absolute phase of the object 101. In the embodiment, software can be used to analyze and process image information. The analyzed phase value is imported into a calibration step or the database module 6 containing Z-axis coordinates and absolute phase ((p) created in the system. The surface shape of the object 101 is restored by comparison, so that the three-dimensional shape of the object 101 can be measured quickly and accurately.

According to the above structure, the color photosensitive coupling device 4 is used for shooting and capturing, and then phase shift technology and phase unwrapping technique are used to obtain a winding phase diagram with a fringe winding phase and an image with an absolute phase. In other words, the present disclosure uses phase shift technology (three-step phase shift method) as the basis. It only needs to use a color fringed image 102 to calculate the phase of the fringe, and then obtain the absolute phase value of the fringe. Finally, based on the absolute phase of the reference plane M as a benchmark, the three-dimensional shape of the object 101 is calculated, and the Z value corresponding to the reference plane M is restored.

As described above, the system for 3D profile measurements using color fringe projection techniques of the present disclosure can accurately identify the phase by phase shift, and then use the phase to restore the three-dimensional shape. When the object 101 forms a color projected fringe, the horizontal displacement of the color projected fringe can be used to calculate the absolute phase of the fringe, thereby improving the accuracy of measurement. Furthermore, the present disclosure only uses the color photosensitive coupling device 4 to capture a color fringed image 102 by facing the object 101 to obtain the phase distribution information of the object 101, and then restore the three-dimensional shape. It can significantly reduce the measurement time required in research and improve work efficiency. The present disclosure only needs to take a momentary photo of a dynamic object, Phase shift technology and phase unwrapping technique are used to obtain continuous phase distribution and restore the three-dimensional shape of the object 101, which is beneficial to the measurement of dynamic objects.

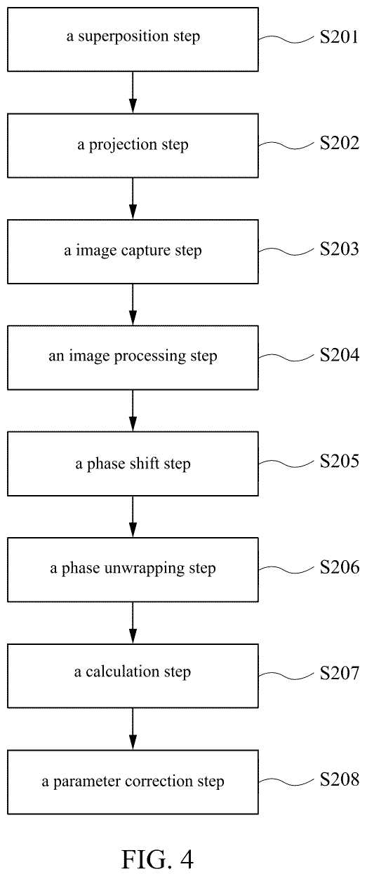

Please refer to FIG. 1 and FIG. 4, a method for 3D profile measurements using color fringe projection techniques according to a preferred embodiment of present disclosure is illustrated. The method comprises a superposition step S201, a projection step S202, an image capture step S203, an image processing step S204, a phase shift step S205, a phase unwrapping step S206, a calculation step S207, and a parameter correction step S208. The relationship and operation principle of each step in present disclosure will be described in detail hereinafter.

Please refer to FIG. 1, FIG. 2, and FIG. 4, in the superposition step S201, a red sinusoidal pattern 21 (see FIG. 3B), a green sinusoidal pattern 22 (see FIG. 3C), and a blue sinusoidal pattern 23 (see FIG. 3D) are superimposed together by a processor 5, to form a color fringe pattern 2, wherein each sinusoidal pattern differs from the other two sinusoidal patterns with a phase-shifted value, specifically, each sinusoidal pattern differs from the other two sinusoidal patterns with a phase-shifted value of 2π/3. In the embodiment, a phase-shifted value (periodic horizontal displacement) of the red sinusoidal pattern 21 is 0, a phase-shifted value of the green sinusoidal pattern 22 is 2π/3, and a phase-shifted value of the blue sinusoidal pattern 23 is 4π/3.

Please refer to FIG. 1, FIG. 2, and FIG. 4, in the projection step S202, a digital projector 3 is used to project the color fringe pattern 2 onto an object 101, so that colorful fringes are projected on a surface of the object 101. In the embodiment, the digital projector 3 is arranged in front of a projection plane P1, and the color fringe pattern 2 is placed on the projection plane P1.

Please refer to FIG. 1, FIG. 2, and FIG. 4, in the capture step S203, a color photosensitive coupling device 4 is used to capture the colorful fringes to obtain a color fringed image 102. In the embodiment, the color photosensitive coupling device 4 is disposed on an imaging plane P2, and the imaging plane P2 and the projection plane P1 are located in different planes.

Please refer to FIG. 1, FIG. 2, and FIG. 4, in the image processing step S204, the color fringed image 102 is analyzed by the processor 5 to obtain a first grayscale image, a second grayscale image, and a third grayscale image, wherein the first grayscale image is derived from a red channel, the second grayscale image is derived from a green channel, and the third grayscale image is derived from the blue channel. An equation for the phase and light intensity of the first grayscale image, the second grayscale image and the third grayscale image is:

$${I}_{d}^{( k )} ( {x}_{d} , {y}_{d} ) = {A}_{d} ( {x}_{d} , {y}_{d} ) + {B}_{d} ( {x}_{d} , {y}_{d} ) cos ( {φ}_{d} ( {x}_{d} , {y}_{d} ) - 2 π ( k - 1 ) / 3 ) ;$$

wherein x_{d} and y_{d} represent an imaging plane P2 of the color fringed image 102; I_{d}^{(k)}(x_{d}, y_{d}) represents the light intensity of the grayscale image, k=1 represents the first grayscale image, k=2 represents the second grayscale image, k=3 represents the third grayscale image; A_{d} is DC term of the grayscale images, B_{d} is amplitude of the grayscale images; φ_{d} is a phase of the fringes of the first grayscale image, the second grayscale image and the third grayscale image.

Please refer to FIG. 1, FIG. 2, and FIG. 4, in the phase shift step S205, the processor 5 performs phase acquisition on the first grayscale image, the second grayscale image, and the third grayscale image to obtain a wrapped phase map of the colorful fringes located on the surface of the object 101. In the embodiment, an equation for the phases of fringes of the colorful fringes is:

$${φ}_{w} ( {x}_{d} , {y}_{d} ) = {tan}^{- 1} [ \frac{{\sum }_{k = 1}^{3} {I}_{d}^{( k )} ( {x}_{d} , {y}_{d} ) sin [ 2 ( k - 1 ) π / 3 ]}{{\sum }_{k = 1}^{3} {I}_{d}^{( k )} ( {x}_{d} , {y}_{d} ) cos [ 2 ( k - 1 ) π / 3 ]} ] ;$$

wherein x_{d} and y_{d} represent an imaging plane P2 of the color fringed image 102; φ_{w}(x_{d}, y_{d}) represents the phase of the colorful fringes limited to between π and −π; k=1 represents the first grayscale image, k=2 represents the second grayscale image, k=3 represents the third grayscale image.

Please refer to FIG. 1, FIG. 2, and FIG. 4, in the phase unwrapping step S206, the processor 5 performs phase unwrapping of the wrapped phase map to obtain an absolute phase corresponding to the object 101. In other words, phase unwrapping technique is used to obtain a continuous phase distribution.

Please refer to FIG. 1 and FIG. 4, in the calculation step S207, the processor 5 uses a triangulation method to calculate a depth from any point on the surface of the object 101 to a reference plane M based on the absolute phase to obtain a three-dimensional shape of the object 101. In the embodiment, the processor 5 calculates the phase difference between the surface of the object 101 and the reference plane M based on the absolute phase, an equation for the depth and the phase difference is:

$$\vec{MN} = {d}_{0} \frac{{φ}_{N} - {φ}_{Q}}{2 π} cos {θ}_{0} ;$$

wherein a projection beam L passes through the reference plane M and intersects on the surface N of the object; the intersection point with the reference plane M after reflection is Q; the distance between light and dark fringes projected onto the reference plane is do; the phase of N is φ_{N}; the phase of Q is φ_{Q}; an angle between a normal line of the projection beam L and the reference plane is θ₀. It should be noted that whether it is the digital projector 3 or the color photosensitive coupling device 4, the images projected or captured have color aberration problems, especially the crosstalk between the channels of the color photosensitive coupling device 4. Specifically, the crosstalk between each channel will produce additional interference, such as the projection of a pure red pattern, but it will appear in the image captured by the green channel and the blue channel at the same time, resulting in a non-negligible deviation in the extracted phase. Moreover, the color of the object 101 will also affect the phase accuracy. For example, a pure red object will make the image captured by the green channel and the blue channel darker, and the gray scale value of its fringe will be smaller. In order to solve the chromatic aberration and crosstalk, the following first correction tool was designed. Furthermore, whether it is the digital projector 3 or the color photosensitive coupling device 4, the lenses used often do not have effects of telecentric imaging formation, so that d₀ and θ₀ are non-constant values and change with position, so further correction is required.

It should be noted that the triangulation method can use the phase difference between the two surfaces of the object 101 and the reference plane M to calculate the distance extending vertically from the surface N of the object 101 to the reference plane M, that is, the height difference \vec{MN}.

By way of example, in the calculation step S207, the reference plane M adopts a white plane, and the depth fluctuation of the reference plane M is less than 1 μm.

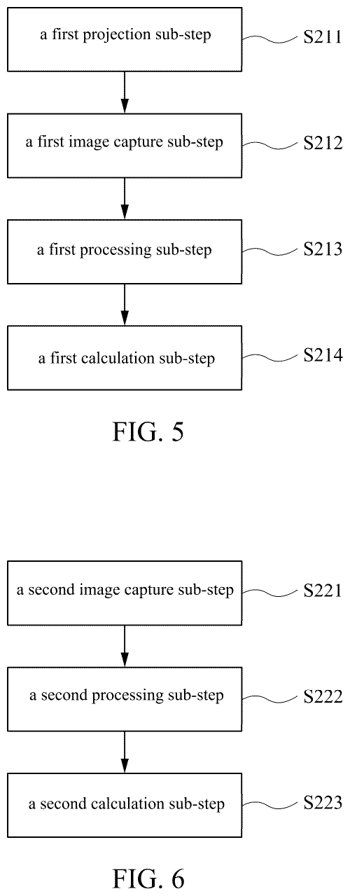

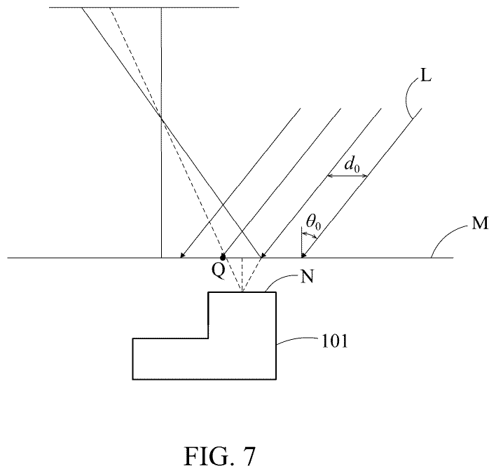

Please refer to FIG. 8 and FIG. 5, in the parameter correction step S208, the parameter correction step S208 comprises a first projection sub-step S211, a first image capture sub-step S212, a first processing sub-step S213, and a first calculation sub-step S214.

Please refer to FIG. 8 and FIG. 5, in the first projection sub-step S211, the digital projector 3 is used to project the color fringe pattern 2 onto a first correction tool 103, and a first projection fringe is formed on a surface of the first correction tool 103. The first correction tool 103 is a planar object, the color and reflectivity of the surface of the planar object are close to or equal to the surface of the object 101. If the colors of the images captured by the planar object and the object 101 are different, the phase extracted by the first correction tool 103 and the phase extracted from the object 101 have a non-negligible deviation.

Please refer to FIG. 8 and FIG. 5, in the first image capture sub-step S212, an operator moves the first correction tool 103 to z-axis positions, such as Z1, Z2, along a z-axis and uses the color photosensitive coupling device 4 to capture images of the first projection fringe to obtain a plurality of first color fringed images corresponding to the z-axis positions.

Please refer to FIG. 8 and FIG. 5, in the first processing sub-step S213, the processor 5 is uses to process the first color fringed images to obtain a plurality of first absolute phases corresponding to the first correction tool 103 located at the z-axis positions.

Please refer to FIG. 8 and FIG. 5, in the first calculation sub-step S214, the processor 5 uses the least squares method to perform calculations to obtain a depth parameter in an equation between the first absolute phases and the z-axis, wherein the equation is:

z=Σₙ₌₀^{N}Cₙφ_{d}ⁿ;

wherein a depth of the z-axis is z; a number of z-axis positions is N; the depth parameter is Cₙ; the first absolute phases is φ_{d}.

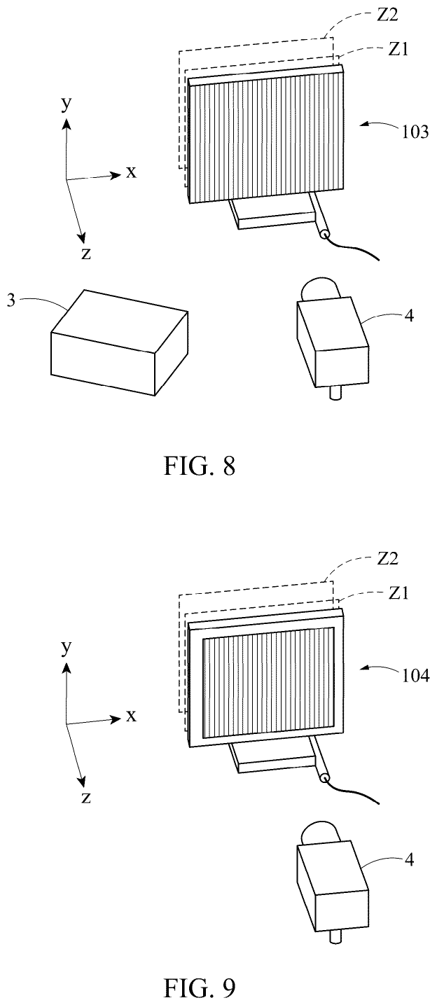

Please refer to FIG. 9 and FIG. 6, in the parameter correction step S208, the parameter correction step S208 further comprises a second image capture sub-step S221, a second processing sub-step S222, and a second calculation sub-step S223.

Please refer to FIG. 9 and FIG. 6, in the second image capture sub-step S221, the operator moves a second correction tool 104 to z-axis positions, such as Z1, Z2, along a z-axis, wherein the second correction tool 104 is a planar object, and the surface of the planar object is painted with chordal stripes. These chordal stripes are arranged at an angle of 45 degrees to the horizontal direction, and the period T is a known fixed value. The color of the chordal stripes does not need to be limited (at least it is not a gradient between white and black), as long as the color photosensitive coupling device 4 can capture a fringe image in any channel. The operator further uses the color photosensitive coupling device 4 to capture images of a color oblique picture 105 (chordal stripes arranged at an angle of 45 degrees) of the second correction tool 104 to obtain a plurality of second color fringed images corresponding to the z-axis positions.

Please refer to FIG. 9 and FIG. 6, in the second processing sub-step S222, a fringe image of at least one channel is captured, and the fringe in the fringe image is chordal (even with crosstalk), the processor 5 uses a one-dimensional Fourier transform method to perform phase extraction of the second color fringed images in the horizontal direction (x-axis) and the vertical direction (y-axis) to obtain a plurality of second absolute phases (φₓ and φ_{y}) corresponding to the z-axis positions of the second correction tool 104. Since the periods of these chordal stripes are known, the x-axis position and y-axis position can be calculated from the absolute phases (φₓ and φ_{y}), and the equations are: φₓ=2πx/Tₓ; φ_{y}=2πy/T_{y}; Tₓ=T_{y}=T cos(π/4).

Please refer to FIG. 9 and FIG. 6, in the second calculation sub-step S223, the processor 5 calculates x-axis positions and y-axis positions corresponding to the z-axis positions based on the second absolute phases, and uses the least squares method to perform calculations to obtain horizontal parameters of an equation comprising the z-axis positions and the x-axis positions and vertical parameters of an equation comprising the z-axis positions and the Y-axis positions, wherein the equations are:

$$x = {a}_{1} z + {a}_{0} ;$$

$$y = {b}_{1} z + {b}_{0} ;$$

wherein a horizontal length of the x-axis is x; a vertical length of the y-axis is y; a depth of the Z axis is z; the horizontal parameters are a₁ and a₀; the vertical parameters are b₁ and b₀.

In the embodiment, the first correction tool 103 and the second correction tool 104 are both planar objects, and the depth fluctuation of the planar objects is less than one-tenth of the sampling point pitch of the color photosensitive coupling device 4.

In the embodiment, the parameter correction step S208 can effectively minimize the impact of the error and correct back the three-dimensional shape image information affected by the error, thereby making the finally obtained three-dimensional shape image information more accurate and reliable. In other words, when taking pictures with a color camera, the crosstalk problem is a common phenomenon. Even if the image is subject to crosstalk in the process of capturing the color fringed image, the present disclosure can still correctly obtain the real spatial coordinate information of the object 101 through the parameter correction.

As described above, the method for 3D profile measurements using color fringe projection techniques of the present disclosure can accurately identify the phase by phase shift, and then use the phase to restore the three-dimensional shape. When the object 101 forms a color projected fringe, the horizontal displacement of the color projected fringe can be used to calculate the absolute phase of the fringe, thereby improving the accuracy of measurement. Furthermore, the present disclosure only uses the color photosensitive coupling device 4 to capture a color fringed image 102 by facing the object 101 to obtain the phase distribution information of the object 101, and then restore the three-dimensional shape. It can significantly reduce the measurement time required in research and improve work efficiency. The present disclosure only needs to take a momentary photo of a dynamic object, Phase shift technology and phase unwrapping technique are used to obtain continuous phase distribution and restore the three-dimensional shape of the object 101, which is beneficial to the measurement of dynamic objects.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be affected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer readable. Some embodiments in accordance with the invention thus comprise a data carrier which comprises electronically readable control signals that are capable of cooperating with a programmable computer system such that any of the methods described herein is performed. Generally, embodiments of the present invention may be implemented as a computer program product having a program code, the program code being effective to perform any of the methods when the computer program product runs on a computer. The program code may also be stored on a machine-readable carrier, for example. Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer. A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile. A further embodiment of the inventive method thus is a data stream or a sequence of signals representing the computer program for performing any of the methods described herein. The data stream or the sequence of signals may be configured, for example, to be transmitted via a data communication link, for example via the internet. A further embodiment includes a processing unit, for example a computer or a programmable logic device, configured or adapted to perform any of the methods described herein. A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example. In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

The present disclosure has been described with preferred embodiments thereof and it is understood that many changes and modifications to the described embodiments can be carried out without departing from the scope and the spirit of the invention that is intended to be limited only by the appended claims.

What is claimed is:

1. A method for 3D profile measurements using color fringe projection techniques, comprising steps of:
a superposition step, superimposing a red sinusoidal pattern, a green sinusoidal pattern, and a blue sinusoidal pattern by a processor to form a color fringe pattern, wherein each sinusoidal pattern differs from the other two sinusoidal patterns with a phase-shifted value;
a projection step, using a digital projector to project the color fringe pattern onto an object, wherein colorful fringes are projected on a surface of the object;
an image capture step, using a color photosensitive coupling device to capture the colorful fringes to obtain a color fringed image;
an image processing step, using the processor to analyze the color fringed image to obtain a first grayscale image, a second grayscale image, and a third grayscale image, wherein the first grayscale image is derived from a red channel, the second grayscale image is derived from a green channel, and the third grayscale image is derived from the blue channel;
a phase shift step, performing phase acquisition on the first grayscale image, the second grayscale image, and the third grayscale image by the processor to obtain a wrapped phase map of the colorful fringes located on the surface of the object;
a phase unwrapping step, performing phase unwrapping on the wrapped phase map by the processor to obtain an absolute phase corresponding to the object; and
a calculation step, calculating a depth from any point on the surface of the object to a reference plane based on the absolute phase to obtain a three-dimensional shape of the object.

2. The method for 3D profile measurements using color fringe projection techniques according to claim 1, in the superposition step, the red sinusoidal pattern comprises a phase-shifted value of 0, the green sinusoidal pattern comprises a phase-shifted value of 2π/3, and the blue sinusoidal pattern comprises a phase-shifted value of 4π/3.

3. The method for 3D profile measurements using color fringe projection techniques according to claim 2, in the image processing step, an equation for the phase and light intensity of the first grayscale image, the second grayscale image and the third grayscale image is:
$${I}_{d}^{( k )} ( {x}_{d} , {y}_{d} ) = {A}_{d} ( {x}_{d} , {y}_{d} ) + {B}_{d} ( {x}_{d} , {y}_{d} ) cos ( {φ}_{d} ( {x}_{d} , {y}_{d} ) - 2 π ( k - 1 ) / 3 ) ;$$
wherein x_{d} and y_{d} represent an imaging plane of the color fringed image; I_{d}^{(k)}(x_{d}, y_{d}) represents the light intensity of the grayscale image, k=1 represents the first grayscale image, k=2 represents the second grayscale image, k=3 represents the third grayscale image; A_{d} is DC term of the grayscale images, B_{d} is amplitude of the grayscale images; φ_{d} is a phase of the fringes of the first grayscale image, the second grayscale image and the third grayscale image.

4. The method for 3D profile measurements using color fringe projection techniques according to claim 3, in the phase shift step, an equation for the phases of fringes of the colorful fringes is:
$${φ}_{w} ( {x}_{d} , {y}_{d} ) = {tan}^{- 1} [ \frac{{\sum }_{k = 1}^{3} {I}_{d}^{( k )} ( {x}_{d} , {y}_{d} ) sin [ 2 ( k - 1 ) π / 3 ]}{{\sum }_{k = 1}^{3} {I}_{d}^{( k )} ( {x}_{d} , {y}_{d} ) cos [ 2 ( k - 1 ) π / 3 ]} ] ;$$
wherein x_{d} and y_{d} represent an imaging plane of the color fringed image; φ_{w}(x_{d}, y_{d}) represents a phase of the colorful fringes limited to between π and −π; k=1 represents the first grayscale image; k=2 represents the second grayscale image; k=3 represents the third grayscale image.

5. The method for 3D profile measurements using color fringe projection techniques according to claim 4, in the calculation step, the processor calculates the phase difference between the surface of the object and the reference plane based on the absolute phase, and an equation for the depth and the phase difference is:
$$\vec{MN} = {d}_{0} \frac{{φ}_{N} - {φ}_{Q}}{2 π} cos {θ}_{0} ;$$
wherein a projection beam L passes through the reference plane M and intersects on the surface N of the object; the intersection point with the reference plane M after reflection is Q; the distance between light and dark fringes projected onto the reference plane is d₀; the phase of N is φ_{N}; the phase of Q is φ_{Q}; an angle between a normal line of the projection beam L and the reference plane is θ₀.

6. The method for 3D profile measurements using color fringe projection techniques according to claim 5, after the calculation step, the method further comprises a parameter correction step, comprising steps of:
a first projection sub-step, using the digital projector to project the color fringe pattern onto a first correction tool, and a first projection fringe is formed on a surface of the first correction tool;
a first image capture sub-step, moving the first correction tool to z-axis positions along a z-axis by an operator and using the color photosensitive coupling device to capture images of the first projection fringe to obtain a plurality of first color fringed images corresponding to the z-axis positions;
a first processing sub-step, using the processor to process the first color fringed images to obtain a plurality of first absolute phases corresponding to the first correction tool located at the z-axis positions; and
a first calculation sub-step, using the least squares method to perform calculations by the processor to obtain a depth parameter in an equation between the first absolute phases and the z-axis, wherein the equation is: z=Σₙ₌₀^{N} Cₙ φ_{d}ⁿ;
wherein a depth of the z-axis is z; a number of z-axis positions is N; the depth parameter is Cₙ; the first absolute phases is φ_{d}.

7. The method for 3D profile measurements using color fringe projection techniques according to claim 6, wherein the parameter correction step further comprises steps of:
a second image capture sub-step, moving a second correction tool to z-axis positions along a z-axis by the operator and using the color photosensitive coupling device to capture images of a color oblique picture of the second correction tool to obtain a plurality of second color fringed images corresponding to the z-axis positions;
a second processing sub-step, using the Fourier conversion method by the processor to perform phase extraction of the second color fringed images to obtain a plurality of second absolute phases corresponding to the z-axis positions of the second correction tool; and
a second calculation sub-step, calculating x-axis positions and y-axis positions corresponding to the z-axis positions based on the second absolute phases by the processor, and using the least squares method to perform calculations to obtain horizontal parameters of an equation comprising the z-axis positions and the x-axis positions and vertical parameters of an equation comprising the z-axis positions and the Y-axis positions, wherein the equations are:
$$x = {a}_{1} z + {a}_{0} ;$$
$$y = {b}_{1} z + {b}_{0} ;$$
wherein a horizontal length of the x-axis is x; a vertical length of the y-axis is y; a depth of the Z axis is z; the horizontal parameters are a₀ and a₀; the vertical parameters are b₁ and b₀.

8. The method for 3D profile measurements using color fringe projection techniques according to claim 7, wherein the first correction tool and the second correction tool are flat objects, and the depth of the plane objects is less than one tenth of a sampling point distance of the color photosensitive coupling device.

9. A system for 3D profile measurements using color fringe projection techniques, comprising:
a color fringe pattern, comprising a red sinusoidal pattern, a green sinusoidal pattern, and a blue sinusoidal pattern, wherein each sinusoidal pattern differs from the other two sinusoidal patterns with a phase-shifted value;
a digital projector, disposed before a projection plane, wherein the color fringe pattern is disposed on the projection plane, the digital projector is configured to project the color fringe pattern on an object, and colorful fringes are projected on a surface of the object;
a color photosensitive coupling device, disposed on an imaging plane, wherein the imaging plane and the projection plane are located in different planes, and the color photosensitive coupling device is configured to capture the colorful fringes to obtain a color fringed image; and
a processor, coupled the color photosensitive coupling device and configured to:
analyze the color fringed image to obtain a first grayscale image, a second grayscale image, and a third grayscale image, wherein the first grayscale image is derived from a red channel, the second grayscale image is derived from a green channel, and the third grayscale image is derived from the blue channel;
perform phase acquisition on the first grayscale image, the second grayscale image, and the third grayscale image to obtain a wrapped phase map of the colorful fringes located on the surface of the object;
perform phase unwrapping of the wrapped phase map to obtain an absolute phase corresponding to the object; and
calculate a depth from any point on the surface of the object to a reference plane based on the absolute phase to obtain a three-dimensional shape of the object.

10. The system for 3D profile measurements using color fringe projection techniques according to claim 9, wherein the system comprises a database module coupled the processor, and the database module is configured to establish the relevant information between the depth of the z-axis and the absolute phase of the object.
